(19) United States
(12) Patent Application Publication
(10) Pub. No.: US 2003/0073368 A1
(43) Pub. Date: Apr. 17, 2003

(54) Two-layer laminate

(75) Inventors: Marc R. Berkhoff, Ede (NL); Paulus C.A.M. Schelbergen, Elst (NL); Jan Dijkema, Zutphen (NL)

Correspondence Address: OLIFF & BERRIDGE, PLC, P.O. BOX 19928, ALEXANDRIA, VA, 22320, US

(73) Assignee: COLBOND B.V., Arnhem (NL)

(21) Appl. No.: 10/269,882

(22) Filed: Oct. 15, 2002

(30) Foreign Application Priority Data
Oct. 17, 2001 (EP) 01124770.7

(51) Int. Cl. B32B 5/16; B32B 5/26; D04H 3/10; D04H 1/00; D04H 3/00

(52) U.S. Cl. 442/389; 442/390; 442/417; 442/402; 442/409; 156/181

(57) ABSTRACT

A two-layer laminate and a process for manufacturing a two-layer laminate including a first nonwoven layer including thermoplastic fibers, wherein the first nonwoven layer is pre-consolidated and pre-shrunk, a second nonwoven layer including glass fibers, and at least one thermoplastic binder, wherein the first nonwoven layer and the second nonwoven layer are bonded together by application of heat, the second nonwoven layer is pre-consolidated and the thermoplastic binder originates from the second nonwoven layer.

### BACKGROUND OF THE INVENTION

1. Field of Invention

The invention relates to a two-layer laminate with a first nonwoven layer including thermoplastic fibers, the first nonwoven layer being pre-consolidated and preshrunk, a second nonwoven layer including glass fibers, and at least one thermoplastic binder, wherein the first nonwoven layer and the second nonwoven layer are bonded together by an application of heat. Furthermore, the invention is directed to a process of manufacturing such a two-layer laminate.

2. Description of Related Art

EP 0 667 427 A1 discloses a process for manufacturing a two-layer textile reinforcement intended for the production of a bituminous roofing sealing sheet, and reinforcements obtained thereof. In the process according to EP 0 667 427 A1, a first layer based on a nonwoven ply is first consolidated by mechanical or hydraulic bonding and heat-stabilizing. Then this consolidated and heat-stabilized first layer is assembled on a mineral filamentary second layer, either by laminating, or by needling or by stitchknitting. In the case of the two layers being assembled by laminating, the adhesive used is a thermosetting or thermoplastic polymer, which is coated in a quantity between 5 and 40 g/m² on the first layer. Assembly is then achieved (e.g., by rotary heating machines). The two-layer laminate manufactured by the process as described in EP 0 667 427 A1 should exhibit excellent thermal stability without exhibiting a curling effect.

EP 0 208 918 A2 is directed to composites of heat-stabilized, mechanically-fastened networks of high tenacity continuous filament polyester yarns, either as the sole continuous filament reinforcing element or in combination with a mat and/or a fiberglass scrim. According to EP 0 208 918 A2, “mechanically fastened” indicates that the network is held together by mechanical means, such as by the warp-knit weft-insertion technique. This patent document thus discloses one or two open grid layers heat-stabilized and/or bonded to each other by the application of heat. Such composites are said to contribute to improved evenness in the final roofing membrane.

EP 0 435 001 A2 provides an at least two-layer laminate and a method of manufacturing thereof. The laminate comprises a first spun-bonded nonwoven layer comprising endless filaments, and a wet laid nonwoven layer comprising short staple inorganic fibers and a thermoplastic binder. The thermoplastic binder, through the application of heat, bonds the laminate. Such laminates should show higher flexibility and, at the same time, be thinner than those known previously.

WO 01/08882 A2 discloses a laminate comprising at least one pre-consolidated non-woven layer containing glass staple fibers needled with at least one thermally shrunken non-woven layer of synthetic fibers, wherein a portion of the fibers of the upper synthetic nonwoven layer passes through the nonwoven layer of glass fibers and wherein the laminate contains a consolidation binder. Here too, better mechanical strength and improved dimensional stability are mentioned as advantages.

### SUMMARY OF THE INVENTION

The related art laminates—although already exhibiting good dimensional stability and evenness—still leave some room for improvement. When, for example, the laminates are used as reinforcements in bituminous roofing membranes, they have to fulfill simultaneously, and, in addition, a variety of other demands, such as flatness, flexibility, thinness, resistance to delamination, high tenacity, good tear strength, sufficient contribution to fire retardancy, easy saturation behavior when being dipped in bitumen and easy and economical manufacturing processes. Although some of the mechanical pretensions can be achieved by the application of laminates comprising glass grids, special and relatively costly measures must be taken to obtain a good fixation of the grid in the laminate, i.e., with a high enough resistance to delamination. Furthermore, usually grids do not contribute to the needed fire retardancy. Two-layer laminates containing glass mats instead of grids require relatively expensive production techniques and/or special additives to overcome the well-known problem of curling, which is inherent to a combination of two different materials.

There is still a need for the provision of laminates exhibiting both the mechanical and fire retardant properties outlined above that are less expensive and easy to produce and to handle.

The invention thus provides a two-layer laminate and a process of manufacturing thereof that combine the above-mentioned technical needs with the advantage of low cost and easy manufacturing.

It has now been found that this objective can be met with a two-layer laminate with a first nonwoven layer including thermoplastic fibers, the first nonwoven layer being pre-consolidated and pre-shrunk, a second nonwoven layer including glass fibers, and at least one thermoplastic binder, wherein the first nonwoven layer and the second nonwoven layer are bonded together by the application of heat and said second nonwoven layer is pre-consolidated and wherein the thermoplastic binder originates from said second nonwoven layer.

It is established that the term “fibers” within the framework of the invention is to be understood in its broadest terminology in accordance with DIN 60 001 or ISO 2076, and that hence by fibers are meant all fibers, irrespective of whether they are virtually endless, i.e., filaments, or structures limited in length, such as staple fibers. Of course the term “fibers” also encompasses mixtures of virtually endless fibers and fibers limited in length.

The thermally bonded two-layer laminate according to the invention comprises nonwoven layers, i.e., mats, and no grids or scrims. Thus, excellent mechanical properties can be achieved. In particular, the laminatry is flat and does not exhibit any curls or undulation, has a remarkable resistance to delamination and offers a substantial contribution to the fire retardancy of the final membrane. It could not be expected from the related art that the object of the invention could be achieved without a scrim.

Preferably, the first nonwoven layer comprises endless fibers, in the form of spun-bonded filaments. The manufacture of a spun-bonded nonwoven layer is known in the art and needs no further elucidation here.

The second nonwoven layer may comprise glass fibers in various forms, such as wetlaid or drylaid staple fibers or filaments, but preferably in the form of staple fibers. It is an essential feature of the laminate according to the invention that the thermoplastic binder used originates from the second non-woven layer, i.e., the glass fiber layer. Such binders are known to those skilled in the art. They are usually thermoplastic polymers, with or without crosslinking agents, such as polyester, preferably copolyester, polyamide, copolyamide, polypropylene, polyurethane, acrylics, ethylene vinyl acetate or a blend of two or more of these agents. Preferably, the thermoplastic binder is in the form of powder, fibrils, fibers or as an emulsion.

Although, the first nonwoven layer may comprise a variety of thermoplastic fibers, such as polyamide, polyolefines or polyesters, it is preferred that the first nonwoven layer of the two-layer laminate predominately consists of polyester and/or co-polyester and even more preferred that this first nonwoven layer predominately consists of polyethylene terephthalate.

Furthermore, this first nonwoven layer in the two-layer laminate is pre-consolidated and pre-shrunk. The pre-consolidation of the first nonwoven layer can be achieved by, but is not limited to, methods known per se, such as calendering, thermal bonding, needling or fluid dynamic—preferably hydrodynamic—treatment of the first nonwoven layer.

Pre-shrinkage can be obtained by heat and/or pressure treatment of the first nonwoven layer at temperatures between 80 and 240° C., preferably from 100 to 220° C.

It is further essential for the invention that the second nonwoven layer, i.e., the layer comprising the glass fibers, is also pre-consolidated. This pre-consolidation in principle can be accomplished thermally or mechanically, e.g., by needling and/or fluidentanglement, such as hydroentanglement. It also can be achieved by means of well-known chemical bonding agents. Such bonding agents are known in the art. It is, however, preferred that the second nonwoven layer is pre-consolidated chemically. It is an advantage of the two-layer laminate according to the invention that the pre-consolidation of the second nonwoven layer is achieved by a different binder than the one that is responsible for the bonding of the two layers. On the other hand it is possible, that the two-layer laminate comprises only one bonding agent that takes care of the pre-consolidation of the second nonwoven layer as well as of the bonding of the two nonwoven layers.

The weight of the first nonwoven layer of the laminate according to the invention is in a range from 50 and 300 g/m², preferably between 80 and 200 g/m². The weight of the second nonwoven layer ranges from 10 to 150 g/m², preferably from 30 to 100 g/m².

The amount of thermoplastic binder is in the range from 5 to 55 weight percent, preferably 10 to 30 weight percent with respect to the amount of glass fibers in the second nonwoven layer.

The laminate according to the invention can be combined with further layers, if desired. It may, e.g., be helpful to combine the two-layer laminate with an additional glass fiber scrim, e.g., in a final process step. The laminate can further contain well-known chemical bonding agents for further consolidation.

The invention is further directed to a process for preparing the two-layer laminate comprising the steps of providing a first nonwoven layer comprising thermoplastic fibers, which is subsequently pre-consolidated and pre-shrunk, providing a second nonwoven layer comprising glass fibers, bonding said first nonwoven layer and said second nonwoven layer together by means of at least one thermoplastic binder and an application of heat, wherein prior to bonding said first nonwoven layer and second nonwoven layer together, said second nonwoven layer is pre-consolidated and the thermoplastic binder is provided within the second nonwoven layer.

In this process, it is preferred that the thermoplastic binder is provided within the second nonwoven layer in the form of powder, fibrils, fibers or as an emulsion. It is preferred for the process that the fibers of the first nonwoven layer predominately are spun from polyester and/or co-polyester, preferably from polyethylene terephthalate. Furthermore, it is of advantage that the second nonwoven layer additionally comprises chemical and/or thermal bonding agents.

The process of the invention does not require the expensive intermediate step of coating of one of the laminate layers. Due to the fact that the thermoplastic binder, preferably in the form of thermoplastic polymers, with or without crosslinking agents, such as polyester, preferably copolyester, polyamide, copolyamide, polypropylene, polyurethane, acrylics, ethylene vinyl acetate or a blend, is provided together with the second nonwoven layer, the bonding step can be performed easier and more economically. For the process it is furthermore advantageous that first and second nonwoven layer are additionally bonded by chemical means.

### DETAILED DESCRIPTION OF PREFERRED EMBODIMENTS

A first nonwoven layer, which consists of spun polyester filaments (4-6 dtex) is provided. This layer has a weight of approximately 160 g/m². This polyester nonwoven layer is pre-consolidated by mechanical needling and subsequently pre-shrunk. Pre-shrinkage is obtained by heating with infrared radiation at a temperature of 125° C. for 8 seconds.

A second nonwoven layer is provided, consisting of 51 weight-percent of glass staple fibers, 34 weight-% of co-polyester staple fibers with a melting point of 200° C. and 15 weight-% of PVA, the latter being used for the pre-consolidation of this wetlaid nonwoven layer.

Bonding the two nonwoven layers together is performed by applying heat using a through air drum. The temperature of the air is 210° C. The resulting bi-laminate is flat after laminating and remains flat also after bituminizing.

What is claimed is:

1. A two-layer laminate, comprising:
a first nonwoven layer comprising thermoplastic fibers, said first nonwoven layer being pre-consolidated and pre-shrunk;
a second nonwoven layer comprising glass fibers; and
at least one thermoplastic binder, wherein said first nonwoven layer and said second nonwoven layer are bonded together by an application of heat, said second nonwoven layer is pre-consolidated and the thermoplastic binder originates from said second nonwoven layer.

2. The two-layer laminate according to claim 1, wherein the thermoplastic binder is in the form of powder, fibrils, fibers or as an emulsion.

3. The two-layer laminate according to claim 1, wherein the fibers of said first nonwoven layer predominately consist of at least one of polyester or co-polyester.

4. The two-layer laminate according to claim 1, wherein the pre-consolidation of said first nonwoven layer is achieved by means selected from the group consisting of calendering, thermal bonding, needling, fluid dynamic treatment, preferably hydrodynamic treatment, or combinations thereof.

5. The two-layer laminate according to claim 1, wherein the pre-shrinkage of the first nonwoven layer is achieved by at least one of heat or pressure treatment of said nonwoven layer at temperatures between 80 and 240° C.

6. The two-layer laminate according to claim 1, wherein the second nonwoven layer additionally comprises at least one of chemical or thermal bonding agents.

7. The two-layer laminate according to claim 6, wherein the second nonwoven layer additionally comprises copolyesters as thermal bonding agents.

8. The two-layer laminate according to claim 1, wherein the fibers of said first nonwoven layer predominately consists of polyethylene terephthalate.

9. The two-layer laminate according to claim 1, wherein the pre-shrinkage of the first nonwoven layer is achieved by at least one of heat or pressure treatment of said nonwoven layer at temperatures between 100 and 220° C.

10. A process for preparing a two-layer laminate, comprising:
providing a first nonwoven layer comprising thermoplastic fibers, which is subsequently pre-consolidated and pre-shrunk;
providing a second nonwoven layer comprising glass fibers;
bonding said first nonwoven layer and said second nonwoven layer together by means of at least one thermoplastic binder; and
applying heat, wherein prior to bonding said first nonwoven layer and second nonwoven layer together, said second nonwoven layer is pre-consolidated and said thermoplastic binder is provided within said second nonwoven layer.

11. The process according to claim 10, wherein the fibers of said first nonwoven layer predominately are spun from at least one of polyester or co-polyester.

12. The process according to claim 10, wherein the second nonwoven layer additionally comprises at least one of chemical or thermal bonding agents.

13. The process according to claim 10, wherein the fibers of the first nonwoven layer are predominately spun from polyethylene terephthalate.

14. The process according to claim 10, wherein the second nonwoven layer additionally comprises copolyesters.
